(19) United States
(12) Patent Application Publication
(10) Pub. No.: US 2010/0006480 A1
(43) Pub. Date: Jan. 14, 2010

(54) Plan Sifter and Drive for a Plan Sifter

(75) Inventor: Jurgen Moosmann, Berg (DE)

Correspondence Address: SHOEMAKER AND MATTARE, LTD, 10 POST OFFICE ROAD - SUITE 100, SILVER SPRING, MD, 20910, US

(73) Assignee: Buhler AG, Uzwil (CH)

(21) Appl. No.: 12/523,422

(22) PCT Filed: Nov. 22, 2007
(86) PCT No.: PCT/CH2007/000584

§ 371 Date: Jul. 16, 2009

(30) Foreign Application Priority Data
Jan. 22, 2007 (DE) 10 2007 004 150.2

(51) Int. Cl. B07B 1/38; B07B 1/42

(52) U.S. Cl. 209/357

(57) ABSTRACT

The invention relates to a plan sifter for sifting, or sieving, flour-like or granular products, comprising at least one compartment. The characterizing part is that each sifting compartment has a dedicated drive. In this manner, the base surface available can be better utilized, and the sifting capacity can be better adjusted to the actual need.

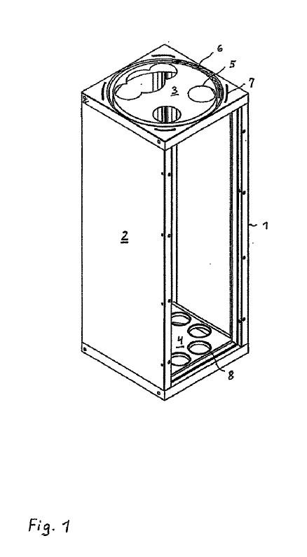

The invention relates to a plan sifter for the sifting or sieving of mealy or granular products, which consists of at least one compartment. The invention also relates particularly to a drive for a plan sifter.

Plan sifters for the sifting of mealy or granular products in mills, in particular in corn mills, are in very widespread use. They have a closable housing with at least one stack of sieves which are arranged one above the other and the covering of which has a mesh width decreasing from the top downwards, so that products of the same particle size ranges can be brought together. For executing the sieving movement, the plan sifter is set in uniformly oscillating motion by means of an unbalance drive.

When a plurality of sieving compartments are arranged in an even number, arrangement may take place in two rows, the drive being arranged between the two rows, as disclosed, for example, in DE 2256307. Furthermore, for example, arrangements of two blocks of four screening compartments with a drive unit lying between them are known (EP-A-1396289).

In order to utilize the space in the drive compartment more effectively, it has also been proposed to arrange sieving compartments at the ends thereof and thus form a closed ring arrangement of sieving compartments (DE-C-197678). Disadvantages are both the poor access to the drive and unequal motion conditions.

Moreover, in all the variants, only even-numbered multiples of sifting compartments can be arranged to form a plan sifter.

The object on which the invention is based is to develop a plan sifter for the sifting or sieving of mealy or granular products, which makes it possible to have both an even number and an odd number of sieving compartments in the plan sifter.

The object is achieved by means of the features of patent claim 1.

A characterizing feature is that each sieving compartment has a dedicated drive. Hence, the available base area can be utilized more effectively and the sifting capacity can be adapted better to actual requirements. Plan sifters with an odd number of sieving compartments can therefore be implemented. Further embodiments are disclosed in the subclaims.

Preferably, the drives have no or only a few mechanically moved parts, and they are synchronizable (in the case of more than one drive or sieving compartment).

A further object is to develop a drive for a plan sifter having at least one sieving compartment.

The drive is, for example, a reluctance motor with ring-shaped toothed disks and outer coils, in each case an identical drive being arranged on the top and on the bottom of a sieving compartment. Further drive principles are, inter alia, asynchronous motors and synchronous motors.

The coils are preferably arranged in the region of the corners of the top and bottom near the toothed disks.

Any desired inlets and outlets for the product to be sifted can be arranged, free of centrifugal force, within the ring-shaped arrangement of the toothed disks.

All the drives must operate synchronously, and, on starting, all masses have to be in the same position.

The same components are used for all the sieving compartments, thus making manufacture and logistics markedly simpler.

The invention is described in more detail below in an exemplary embodiment with reference to a drawing. The drawing shows an open sieving compartment of a plan sifter without a door and without a suspension.

The sieving compartment 1 consists in the usual way of side walls 2, a top 3 having inlet orifices 5 for the product to be sifted and a bottom 4 having outlet orifices 8 for the sifted product. Sieves, not illustrated, are arranged on the inside of the sieving compartment 1 in the usual way to form a sieving stack.

Toothed disks 6 are arranged in segments in the form of a ring on the top 3 and on the bottom 4 on the outside in the same way, all the inlet and outlet orifices 5, 8 being arranged inside the ring of toothed disks 6.

Coils 7 are assigned to the toothed disks 6 in the region of the corners of the top 3 and bottom 4 such that a reluctance motor is formed, such as is disclosed, for example, in DE-A-19704576.

The two drives are operated synchronously by means of a control, not illustrated. On starting, the masses of the toothed disks must be in the same position in both drives in order to achieve rapid starting. This applies similarly to all the sieving compartments 1 of the plan sifter, since each sieving compartment 1 is provided with the abovementioned drives.

The plan sifter formed from at least one sieving compartment 1 is suspended, freely oscillating, in the usual way on flexible bars on the ceiling of a sieve tray.

Depending on the available space or other criteria, each sieving compartment 1 may be suspended individually and/or be arranged in any desired number to form conventional plan sifters.

1-8. (canceled)

9. A plan sifter for the sifting or sieving of mealy or granular products, comprising
at least one sieving compartment with sidewalls and a top and also a bottom with orifices for the product,
a drive,
said sieving compartment being set in uniformly oscillating motion by said drive,
the plan sifter being arranged so as to oscillate freely, wherein
a drive device is arranged in each case on the top and on the bottom.

10. The plan sifter as claimed in claim 9, wherein said drive consists of toothed disks arranged in the form of a ring and of coils assigned to these on the outer ring.

11. The plan sifter as claimed in claim 9, wherein inlet orifices and outlet orifices for the product are provided in the top and bottom within the toothed disks arranged in the form of a ring.

12. The plan sifter as claimed in claim 9, wherein the plan sifter comprises up to twelve sieving compartments.

13. The plan sifter as claimed in claim 9, wherein all the drives are controlled and operated synchronously.

14. A drive for a plan sifter for the sifting or sieving of mealy or granular products, comprising
at least one sieving compartment with side walls and a top and also a bottom with orifices for the product,
a drive,
said sieving compartment being set in uniformly oscillating motion by said drive,
the plan sifter being arranged so as to oscillate freely,
wherein said drive comprises toothed disks arranged in the form of a ring and coils assigned to these on the outer ring, and also a control unit.

15. The drive as claimed in claim 14, wherein said drive is arranged on the top and on the bottom, the coils being arranged in each case in the region of the corners of the top and bottom.

16. The drive as claimed in claim 14, wherein all said drives are synchronizable by means of the control unit.
